(19) United States
(12) Patent Application Publication
(10) Pub. No.: US 2022/0325658 A1
(43) Pub. Date: Oct. 13, 2022

(54) FUEL INJECTOR NOZZLE IN COMBINATION WITH THERMAL BARRIER COATING ON COMBUSTION CHAMBER SURFACE

(71) Applicant: Caterpillar Inc., Peoria, IL (US)

(72) Inventors: Chad Palmer Koci, Washington, IL (US); Yongli Qi, Peoria, IL (US); Jason Jon Rasmussen, Hopewell, IL (US); Daniel J. Sordelet, Peoria, IL (US)

(73) Assignee: Caterpillar Inc., Peoria, IL (US)

(21) Appl. No.: 17/229,446

(22) Filed: Apr. 13, 2021

(51) Int. Cl. F02B 23/06

(52) U.S. Cl. CPC F02B 23/0651; F02B 23/0669; F02B 2275/14; F02B 23/0696

(57) ABSTRACT

Operating an engine includes moving a piston in a combustion chamber between a bottom dead center position and a top dead center position in an engine cycle. A fuel is injected into the combustion chamber through a plurality of sets of nozzle outlets varied set-to-set with respect to outlet size and spray angle. Spray jets of the injected fuel are propagated in an impingement-limiting fuel spray pattern that is based on the set-to-set variation in outlet size and spray angle so as to limit dissipation of heat from combustion of the injected fuel to material of the engine by way of a thermal barrier coating (TBC) upon a surface of the combustion chamber.

This invention was made under United States Department of Energy Contract No. DE-EE0008476. The Government has certain rights in this invention.

### TECHNICAL FIELD

The present disclosure relates generally to an internal combustion engine, and more particularly to limiting dissipation heat from combustion of fuel using a thermal barrier coating (TBC) upon a surface of a combustion chamber.

### BACKGROUND

Internal combustion engines are used throughout the world for diverse applications ranging from propelling machines, powering pumps, compressors, and industrial equipment to production of electrical power. Engineers have long sought strategies for improving emissions, efficiency, and power density in internal combustion engines. In recent years, interest in downsizing, and increasing specific power capabilities of engines has increased dramatically. A relatively smaller, lighter engine that can provide performance formerly capable only with a larger and heavier engine has many advantages.

Decreased size and increased power density of an engine, however, can create challenges respecting temperature control and heat transfer to maintain durability and optimize performance. In other words, absent mitigation a relatively smaller engine capable of producing a relatively greater output of power can subject components and materials of the engine to higher temperatures that must be managed to prevent damage or performance degradation. Moreover, dissipation of heat from an engine can ultimately detract from the power output that can be theoretically realized.

Strategies have been proposed which apply a thermal barrier coating (TBC) to surfaces of a combustion chamber in an internal combustion engine. The TBC creates a barrier that reduces an amount of heat transfer into a base component of the combustion chamber, enabling more fuel to be burned and higher engine power achieved without unduly increasing base component temperatures. U.S. Pat. No. 5,384,200 to Giles et al. is directed to a thermal barrier coating and method of depositing the same on combustion chamber component surfaces. Giles et al. apparently deposit a TBC on surfaces of a combustion chamber component in a compression-ignition engine. The TBC is a dual layer having a first metallic layer of MCrAlY, and a porous ceramic layer of Yttria partially-stabilized zirconia or Ceria-Yttria partially-stabilized zirconia deposited on the metallic layer. While the specific compositional and application strategy of Giles et al. may have applications, the concept does not appear to consider the importance of the manner and/or mechanisms of fuel delivery in performance of the TBC. There is ample room for improvements and development of alternative strategies in the art.

### SUMMARY OF THE INVENTION

In one aspect a method of operating an engine includes moving a piston in a combustion chamber in the engine between a bottom dead center position and a top dead center position in an engine cycle. The method further includes injecting a fuel into the combustion chamber through a plurality of sets of nozzle outlets varied set-to-set with respect to both outlet size and spray angle. The method still further includes propagating spray jets of the injected fuel through the combustion chamber in an impingement-limiting fuel spray pattern that is based on the set-to-set variation in both outlet size and spray angle, and limiting dissipation of heat from combustion of the injected fuel to material of the engine by way of a thermal barrier coating (TBC) upon a surface of the combustion chamber.

In another aspect, an engine includes an engine housing having a combustion chamber formed therein, and a piston movable in the combustion chamber between a bottom dead center position and a top dead center position. The engine further includes a thermal barrier coating (TBC) upon the piston and exposed to the combustion chamber, and a fuel injector nozzle assembly within the combustion chamber and having formed therein a plurality of sets of nozzle outlets varied set-to-set with respect to both outlet size and spray angle.

In still another aspect, an internal combustion system includes an engine having a cylinder block, a cylinder liner in the cylinder block, a cylinder head, and a piston movable in the engine between a bottom dead center position and a top dead center position in an engine cycle. A combustion chamber is formed by an exposed surface of each one of the cylinder liner, the cylinder head, and the piston. A thermal barrier coating (TBC) is upon at least one of the exposed surfaces of the cylinder liner, the cylinder head, and the piston. The internal combustion system further includes a fuel injector nozzle assembly within the combustion chamber, and having formed therein a plurality of sets of nozzle outlets. The plurality of sets of nozzle outlets are varied set-to-set with respect to at least one of outlet size or spray angle, and define an impingement-limiting fuel spray pattern.

### BRIEF DESCRIPTION OF THE DRAWINGS

FIG. 1 is a diagrammatic view of an internal combustion system having an engine, according to one embodiment;

FIG. 2 is a partially sectioned diagrammatic view of a portion of a fuel injector, according to one embodiment;

FIG. 3 is an end view of the fuel injector of FIG. 2;

FIG. 4 is a diagrammatic view of a portion of a piston and fuel spray pattern from a fuel injector, according to one embodiment;

FIG. 5 is a sectioned diagrammatic view of a fuel injector, according to another embodiment;

FIG. 6 is a sectioned diagrammatic view of a fuel injector, according to another embodiment;

FIG. 7 is an illustration of fuel spray and combustion patterns in a combustion chamber, according to one embodiment;

FIG. 8 is an illustration of a fuel spray pattern, according to one embodiment; and

FIG. 9 is a plot of fuel efficiency in comparison to closed-cycle heat transfer for varied fuel injection parameters in an engine, according to one embodiment.

### DETAILED DESCRIPTION

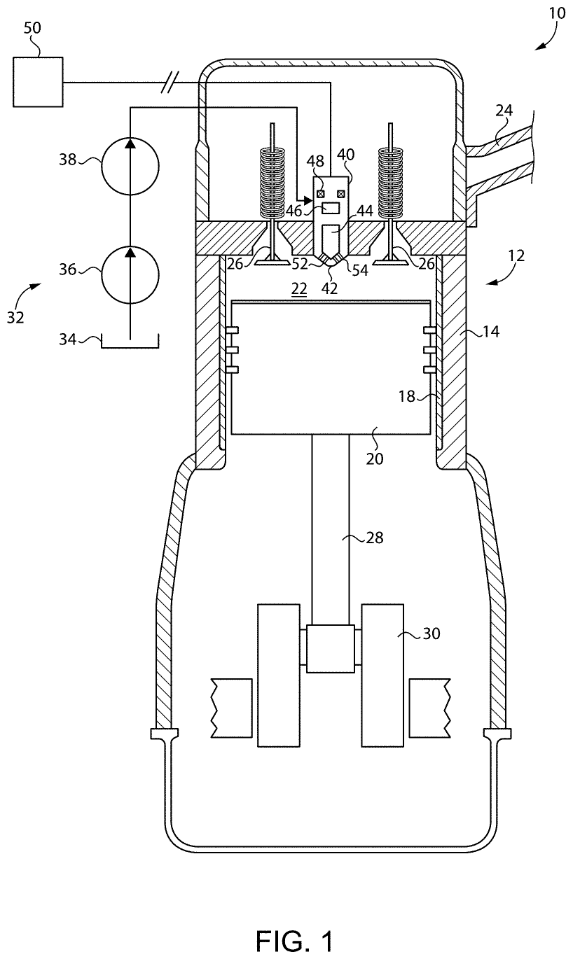

Referring to FIG. 1, there is shown an internal combustion system 10 including an internal combustion engine 12. Internal combustion engine 12 includes an engine housing or cylinder block 14, a cylinder head 16 attached to cylinder block 14, and a cylinder liner 18 within cylinder block 14. A piston 20 is movable in internal combustion engine 12 between a bottom dead center position and a top dead center position, typically in a four-stroke engine cycle. Internal combustion engine 12 can be a compression-ignition engine such that piston 20 operates to increase a pressure of a fuel and air to an autoignition threshold. In other embodiments, internal combustion engine 12 could be spark-ignited, prechamber ignited, or operated according to still another ignition principal. Internal combustion engine 12 further has a combustion chamber 22 formed therein, and in particular formed by an exposed surface of each one of cylinder liner 18, cylinder head 16, and piston 20. Piston 20 is coupled to a crankshaft 30 by way of a connecting rod 28 in a generally conventional manner. Engine valves 26, including at least one intake valve and at least one exhaust valve, are supported in cylinder head 16 and operable to control fluid communication between combustion chamber 22 and an air intake conduit 24 and an exhaust conduit (not shown) in a generally conventional manner. Combustion chamber 22 can be one of any number of combustion chambers or cylinders in any suitable arrangement in cylinder block 14, such as an inline pattern, a V-pattern, or still another.

Internal combustion engine 12 further includes a fuel system 32 having a fuel tank 34, a fuel transfer pump 36, and a fuel pressurization pump 38. Fuel system 32 also includes a fuel injector 40, supported in cylinder head 16, and having a nozzle assembly 42 positioned in combustion chamber 22. Internal combustion engine 12 can operate on any of a variety of liquid fuels including a diesel distillate fuel, a biodiesel fuel, gasoline, methanol or other alcohol fuels, or still others. In a so-called dual fuel application internal combustion engine 12 could operate on a liquid fuel and also a gaseous fuel such as natural gas, methane, propane, or still others. In the illustrated embodiment, fuel pressurization pump 38 is illustrated separate from fuel injector 40 and could be structured to pressurize fuel to be supplied to a common fuel pressurization reservoir or common rail that fluidly connects to a plurality of fuel injectors. Fuel injector 40 could alternatively be equipped with or associated with a so-called unit pump that is cam-actuated, or fuel could be delivered and pressurized by a variety of other mechanisms. Fuel system 32 also includes an electronic control unit 50 in control communication with fuel injector 40, and potentially also connected to other components in fuel system 32 or internal combustion system 10 generally.

Fuel injector 40 includes a nozzle assembly 42 as noted above. An outlet check 44 is movable within fuel injector 40 to control starting and stopping of fuel injection as further discussed herein. Outlet check 44 may be directly hydraulically controlled. To this end, fuel injector 40 may also include a control valve 46 including or coupled with an electrical actuator 48 such as a solenoid. Energizing and deenergizing solenoid 48 using electronic control unit 50 moves control valve 46 to vary a closing hydraulic pressure on outlet check 44 in a generally known manner. Fuel injector nozzle assembly 42 also has formed therein a plurality of sets of nozzle outlets varied set-to-set with respect to at least one of outlet size or spray angle. In the illustrated embodiment, the plurality of sets of nozzle outlets includes a first nozzle outlet set 52 and a second nozzle outlet set 54, varied set-to-set with respect to both outlet size and spray angle. Other embodiments could include more than two nozzle outlet sets. A “set” as contemplated herein includes at least one nozzle outlet. As will be further apparent from the following description, operating internal combustion engine 12 enables propagating spray jets of injected fuel through combustion chamber 22 in an impingement-limiting fuel spray pattern, where the spray pattern is based on the set-to-set variation in outlet size and/or spray angle. As also further discussed herein, the combination of certain fuel injector design and operating characteristics enables limiting dissipation of heat from combustion of injected fuel in an engine cycle to material of engine 12 by way of a thermal barrier coating (TBC) upon one or more exposed surfaces of combustion chamber 22.

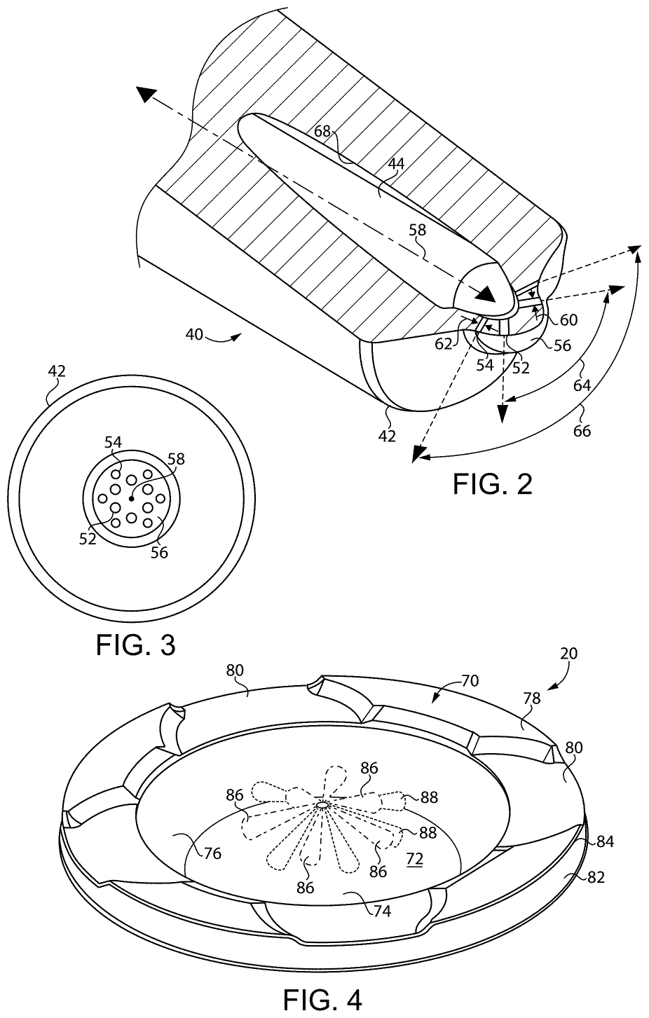

Referring also now to FIG. 2, there are shown certain features of fuel injector 40 and nozzle assembly 42 in further detail. Nozzle assembly 42 includes a tip 56. Fuel injector 40 defines a longitudinal axis 58. First nozzle outlet set 52 includes a plurality of nozzle outlets 52 extending between a nozzle passage 68 and an outer surface (not numbered) of nozzle assembly 42 within tip 56. Second nozzle outlet set 54 also includes a plurality of nozzle outlets 54 similarly extending between nozzle passage 68 and the tip outer surface. By lifting outlet check 44 from a closed position, as depicted in FIG. 2, blocking all of nozzle outlets 52 and nozzle outlets 54, to an open position, fuel from nozzle passage 68 is advanced through nozzle outlets 52 and nozzle outlets 54 to spray into combustion chamber 22. In one embodiment, injection of fuel includes injecting a liquid fuel through the plurality of nozzle outlet sets 52 and 54, and autoigniting the injected liquid fuel for combustion with air in combustion chamber 22. Injection of fuel can also include injecting the fuel through each of the plurality of nozzle outlet sets 52 and 54 at the same injection pressure and at the same injection timing. In other embodiments, further discussed herein, fuel could be injected through the respective nozzle outlet sets at different injection pressures and/or at different injection timings. Thus, it will be appreciated that lifting one nozzle check in a fuel injector from a closed position blocking all of a plurality of nozzle outlets, to an open position not blocking all of a plurality of nozzle outlets, is but one implementation.

It will be recalled that the plurality of sets of nozzle outlets are varied set-to-set with respect to outlet size and/or spray angle. It has been discovered that limiting impingement of injected fuel upon combustion chamber surfaces, and including limiting robust or extensive impingement at least early in an expansion stroke in an engine cycle, can assist in functioning of a TBC to limit dissipation of heat out of a combustion chamber to material of an engine, such as material of piston 20 for example. TBC's may have surface roughness characteristics that can impact flow and produce different boundary conditions relative to conventional combustion chamber surfaces. Interactions between TBC's and fluids within a combustion chamber, including atomized fuel spray, can be unpredictable and adversely impact performance of the TBC.

In some embodiments, nozzle outlets 52 are from 4 to 7 in number, and nozzle outlet sets 54 are from 4 to 7 in number. In the illustrated embodiment, nozzle outlets 52 are 6 in number and nozzle outlets 54 are 6 in number. Nozzle outlets 52 define a smaller spray angle 64 and nozzle outlets 54 define a larger spray angle 66. Nozzle outlets 52 also have a larger outlet size and nozzle outlets 54 have a smaller outlet size in the illustrated embodiment. Thus, both outlet size and spray angle are varied set-to-set. In FIG. 2 a spray outlet size dimension of nozzle outlets 54 is shown at 60, and a spray outlet size dimension of nozzle outlets 54 is shown at 62. Spray outlet size dimension 60 and spray outlet size dimension 62 may include a larger nozzle outlet exit diameter and a smaller nozzle outlet exit diameter, respectively. In a refinement, nozzle outlet size dimension 60 may be about 0.250 millimeters, and nozzle outlet size dimension 62 may be about 0.125 millimeters, thus size dimension 60 is about twice dimension 62, although the present disclosure is not limited as such. A range of spray angle 64 and spray angle 66 may be from about 120° to about 160°, and in a refinement spray angle 64 may be about 130° and spray angle 66 may be about 160°. As used herein the term “about” means generally or approximately, and absent an art-recognized tolerance or approximation can be understood in the context of conventional rounding to a consistent number of significant digits. Thus, “about 120” would mean between 115 and 124, and so on. Where the term “about” is not used in connection with a dimensional or geometric quantity, that quantity can be understood to be within measurement error or another tolerance or approximation that would be routinely applied by a person skilled in the art. It can also be noted from FIG. 2 that in the illustrated example nozzle outlets 52 having a larger outlet size and a smaller spray angle are positioned axially outward of nozzle outlets 54 having a smaller outlet size and a larger spray angle. Axially outward in this context means a direction along an axis away from a geometric center point of a physical body defining that axis. Axially inward means an opposite direction.

Referring also now to FIG. 3, there is shown an end view of nozzle assembly 42. There can be seen nozzle outlets 52 and nozzle outlets 54 distributed circumferentially, within each set, around longitudinal axis 58. It can also be seen that nozzle outlets 52 are radially inward of nozzle outlets 54. In other embodiments, nozzle outlets 52 and nozzle outlets 54 could all be on a common circle centered, for example, on longitudinal axis 58, nozzle outlets 52 could be radially outward of nozzle outlets 54, or some other arrangement could be employed. Each of nozzle outlets 52 and nozzle outlets 54 may be straight cylindrical bores. In other embodiments, rather than straight cylindrical bores tapered shapes of one or both of nozzle outlet sets 52 and 54 might be employed, narrowed outwardly or enlarged outwardly, having trumpet shapes, non-circular cross-sections or various other configurations. It will generally be desirable to structure nozzle assembly 42 and nozzle outlets 52 and 54 such that spray jets produced do not impinge one another or only to a minor extent, as will be further apparent by way of the following description and accompanying illustrations.

Referring now also to FIG. 4, there are shown features of piston 20 in further detail. It will be recalled that exposed surfaces of each one of cylinder liner 18, cylinder head 16, and piston 20 form combustion chamber 22. A TBC is upon at least one of the respective exposed surfaces. In the embodiment of FIG. 4, a TBC 84 is upon an entirety of a combustion face 70 of piston 20. It can also be noted that combustion face 70 forms a combustion bowl 72 and a piston rim 78 extending circumferentially around combustion bowl 72. Parts or all of an inner peripheral surface of cylinder liner 18, a fireside surface of cylinder head 16, or valve end faces of one or both of engine valves 26 could also be equipped with a TBC in addition to, or as an alternative, to forming TBC 84 upon piston 20. Piston 20 may also be structured such that a plurality of valve pockets 80 are formed in piston rim 78. In other embodiments a pocketless piston rim configuration could be used. Combustion bowl 72 may have a center cone (not numbered), and a bowl floor 74 extending peripherally outward to an outer wall 76 of combustion bowl 72. An outer peripheral surface 82 of piston 20 adjoins piston rim 78. Combustion bowl 72 may have a reentrant profile as in the illustrated embodiment, however, the present disclosure is also not limited in this regard.

Piston 20 may be formed from a variety of different materials, typically containing iron, such as steel, stainless steel, and various iron alloys. Aluminum pistons may also fall within the scope of the present disclosure. TBC 84 can be any of a variety of known and commercially available TBC's applied by any suitable strategy and having any suitable composition. One example TBC includes a multi-layer coating including a topcoat and a bond coat upon a steel piston substrate of 4140 steel. The topcoat might be 95% YSZ (SG204) and 5% NiCrAl (Metco 443 NS) with the bond coat being NiCrAl. In another example the topcoat is 50% cordierite (STC) and 50% YSZ (SG204), and the bond coat is NiCrAl. Those skilled in the art will find various alternative compositional forms of a suitable TBC.

FIG. 4 also illustrates spray jets of injected fuel in an example impingement-limiting fuel spray pattern based on the set-to-set variation in both outlet size and spray angle among nozzle outlets 52 and nozzle outlets 54. Spray jets 86 are shown as they might appear propagating outward from nozzle outlets 54, and spray jets 88 are shown as they might appear propagating outward from nozzle outlets 52. It can be seen from FIG. 4 that spray jets 88 are advanced further outward and targeted downward into combustion bowl 72 relative to spray jets 86. In particular, spray jets 88 may be targeted to advance along combustion bowl floor 74. Spray jets 86 may be targeted above targeted spray jets 88. Particular targeting may depend upon start of injection timing, which will typically be at, just prior to, or just after piston 20 reaches a top dead center position at the end of a compression stroke, although the present disclosure is not thereby limited. During operating internal combustion engine 12 the propagation paths of spray jets 86 and 88 according to the impingement-limiting spray pattern will assist in optimal performance of TBC 84 to limiting heat dissipation out of combustion chamber 22, as also further discussed herein. A flow split between spray jets 86 and 88 may be such that from 60% to 95% of a total fuel quantity injected in an engine cycle is injected through first nozzle outlet set 52 in at least some embodiments.

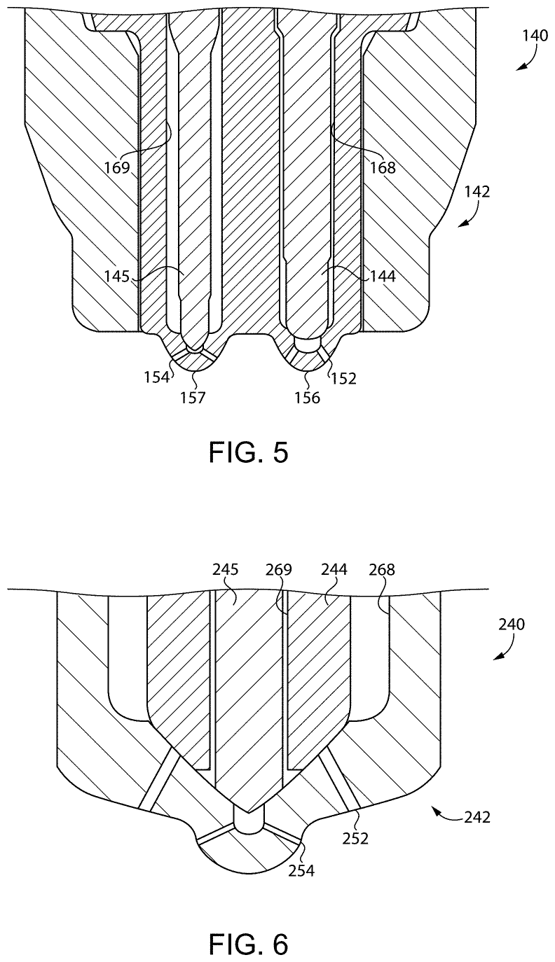

Referring also now to FIG. 5, it will be recalled that various different fuel injector nozzle configurations and operating strategies are contemplated within the context of the present disclosure. In FIG. 5, a dual side-by-side check fuel injector 140 is shown. Fuel injector 140 includes a nozzle assembly 142 having a first tip 156 and a second tip 157. A first outlet check 144 is positioned to control opening and closing of a first nozzle outlet set 152 formed in first tip 156. A second outlet check 145 is positioned to control opening and closing of a second nozzle outlet set 154 formed in second tip 157. When nozzle outlets 152 are open, and outlet check 144 lifted, nozzle outlets 152 are fluidly connected to a nozzle passage 168. When nozzle outlets 154 are opened, and outlet check 145 lifted, nozzle outlets 154 are fluidly connected to another nozzle passage 169. Nozzle outlets 152 may have a larger outlet size and a smaller spray angle. Nozzle outlets 154 may have a smaller outlet size and a larger spray angle. The numbers, configurations, arrangement, spray angles, and other attributes of nozzle outlets 152 and nozzle outlets 154 may be analogous to those described in connection with the foregoing embodiments. Providing two separate nozzle passages 168 and 169 can enable the same fuel at different injection pressures or at the same injection pressure to be supplied to the respective nozzle outlets 152 and 154. Alternatively, different fuels could be supplied to the respective nozzle outlets at the same or different injection pressures. In still other instances, different spray angles but the same outlet sizes in two nozzle outlet sets could be used in combination with different injection pressures to achieve an impingement-limiting fuel spray pattern. Thus, in some embodiments only spray angle of nozzle outlets may be varied set-to-set. In other embodiments only outlet size might be varied set-to-set. Outlet checks 144 and 145 could also be operated independently to vary a start of injection timing, an end of injection timing, or a duration or rate shape of injection, between the respective nozzle outlets 152 and 154. It can also be seen that fuel injector 140 includes components commonly housed in a single injector. Other embodiments could include two separate fuel injectors. Thus, it should be appreciated that the term “nozzle assembly” contemplates a single-nozzle fuel injector, a multiple-nozzle fuel injector, or separate fuel injectors commonly supported in a cylinder head.

Turning now to FIG. 6, there is shown a fuel injector 240 according to another embodiment. Fuel injector 240 includes a nozzle assembly 242 having a first set of nozzle outlets 252 and a second set of nozzle outlets 254 formed therein. Fuel injector 240 also includes a first outlet check 244 and a second outlet check 245. In contrast to a side-by-side dual check arrangement, outlet check 244 and outlet check 245 are concentric. A first nozzle passage 268 is positioned to supply a fuel to nozzle outlets 252 when outlet check 244 is lifted. A second nozzle passage 268 supplies a fuel to nozzle outlets 254 when outlet check 245 is lifted. Nozzle outlets 252 may have a larger outlet size and a smaller spray angle. Nozzle outlets 254 may have a smaller outlet size and a larger spray angle. Again, nozzle outlets 252 and 254 may be structured and arranged analogously to nozzle outlets described in connection with other embodiments to produce an impingement-limiting fuel spray pattern. Outlet checks 244 and 245 could be lifted independently, or lifted together, to provide a range of injection timing, and duration, and rate shape possibilities.

### INDUSTRIAL APPLICABILITY

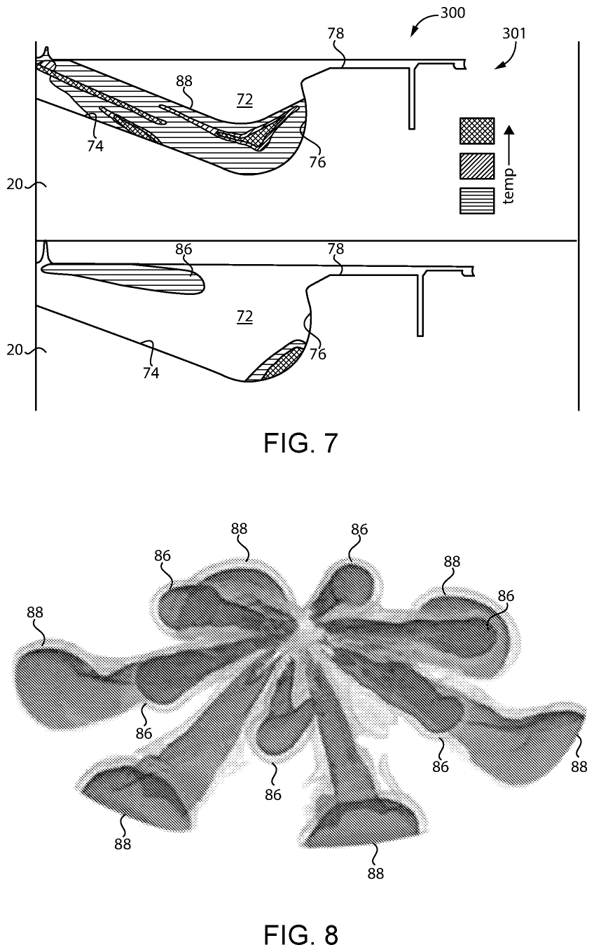

Referring to the drawings generally, but also now to FIG. 7 and in particular reference to the injector embodiment of FIGS. 2-4, there is shown an illustration 300 of a spray jet 88 and a spray jet 86, as those spray jets might appear at or just shortly after starting fuel injection at a piston top dead center position. It will be understood the image of spray jet 88 is taken through spray jet 88 and the image of spray jet 86 is taken circumferentially between spray jet 88 and spray jet 86. A legend 301 identifies temperatures that might be observed in the spray jets as ignition occurs and diffusion combustion commences. It can be seen that spray jet 88 has travelled along combustion bowl floor 74 and begun to ascend outer wall 76. Portions of spray jet 88 are actively combusting by way of diffusion burning, evident in the highest temperature portions thereof. In the lower image in FIG. 7 spray jet 86 is seen to have penetrated less deeply into combustion chamber 72. It will be recalled that spray jet 86 may be injected through a smaller nozzle outlet and at a larger spray angle, whereas spray jet 88 is injected at a smaller spray angle and through a larger nozzle outlet. Thus spray jet 86 lags behind spray jet 88 in propagating outwardly. Referring also to FIG. 8, there are shown spray jets 86 and 88 as they might appear propagating through combustion chamber 72 in an impingement-limiting fuel spray pattern. Based upon the smaller nozzle outlet size of nozzle outlets 54 in this example, spray jets 86 will tend not to reach the vicinity of piston rim 78, much less cylinder liner 18, during operation, prior to combusting. As a result, a relatively larger total quantity of fuel can be injected than might otherwise be possible without resulting in extensive impingement upon surfaces of piston 20 coated with TBC 84. As noted above, limiting such impingement is believed to optimize performance of TBC 84. The present disclosure thus contemplates taking greater advantage of available volume of the combustion chamber by providing better dispersing of injected fuel without impinging the fuel upon surfaces formed by a TBC. Such capabilities can be desirable particularly where smaller engine footprint and greater power density is desirable. In other words, with a relatively small and power dense engine it can be challenging to deliver sufficient fuel for high power output without spraying the fuel onto surfaces of a combustion chamber, thus interfering with TBC performance and resulting in higher base component material temperatures and higher heat dissipation than what could theoretically be achieved.

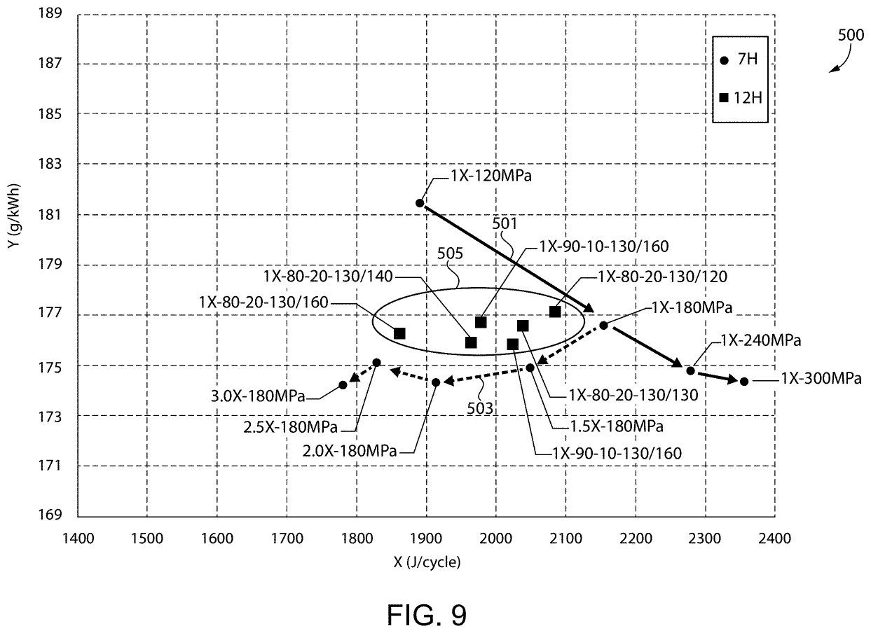

Referring now to FIG. 9, there is shown a plot 500 illustrating trends that can be expected by varying certain properties of fuel injector construction and operation in an engine employing a TBC on a piston combustion face. Plot 500 illustrates a number of data points for injectors varying flow factor, flow split or apportionment between nozzle outlet sets, spray angles of nozzle outlet sets, and injection pressure. Efficiency, in grams fuel burned per kilowatt hour produced, is shown on the Y-axis. Total closed-cycle heat transfer in joules per cycle is shown on the X-axis. Flow factor can be understood as a nominal amount that an injector nozzle flows, and varied by changing the number of individual nozzle outlets, the size of the outlets, or both. Thus, a 3.0× flow factor would represent a three-fold increase of total flow area that produces three times the fuel flow rate for the same injection pressure.

In FIG. 9, an injection pressure trend line is shown at 501, an injector flow trend line is shown at 503, and a split flow trend line or zone is shown at 505. Data points establishing injection pressure trend line 501 include seven-hole (7H) injectors with a flow factor 1× and injection pressures at 120 MPa, 180 MPa, and 240 MPa, as can be seen in FIG. 9. Injection pressure trend line 501 shows that increasing injection pressure while maintaining flow factor can impart greater fuel efficiency and greater closed cycle heat transfer. Data points establishing injector flow trend line 503 include seven-hole (7H) injectors, injection pressure of 180 MPa, and flow factors at 1.5×, 2.0×, 2.5×, and 3.0×. Injector flow trend line 503 shows that increased fuel flow can impart increased fuel efficiency and decreased closed cycle heat transfer. Data points in split flow line or zone 505 include 12 hole (12H) injectors with 6 holes in each of two nozzle outlet sets, a flow factor of 1×, and different flow splits between nozzle outlet sets at different spray angles. Thus, 1×-90-10-130/160 means a flow factor of 1× and a proportional flow split of 90% to 10% between two nozzle outlet sets at 130° and 160°, respectively. The data point 1×-80-20-130/160 means a flow factor of 1× and a proportional flow split of 80% to 20% between two nozzle outlet sets at 130° and 160°, respectively, and so on. Split flow trend line or zone 505 shows that when fuel flow is apportioned between different nozzle outlet sets that a desirable trend or zone with respect to both efficiency and heat transfer can be achieved.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method of operating an engine comprising:
moving a piston in a combustion chamber in the engine between a bottom dead center position and a top dead center position in an engine cycle;
injecting a fuel into the combustion chamber through a plurality of sets of nozzle outlets varied set-to-set with respect to both outlet size and spray angle;
propagating spray jets of the injected fuel from each respective set of the plurality of sets of nozzle outlets through the combustion chamber in an impingement-limiting fuel spray pattern that is based on the set-to-set variation in both outlet size and spray angle; and
limiting dissipation of heat from combustion of the injected fuel to material of the engine by way of a thermal barrier coating (TBC) upon a surface of the combustion chamber.

2. The method of claim 1 wherein the limiting of dissipation of heat includes limiting dissipation of heat to material of the piston by way of a TBC upon a combustion face of the piston.

3. The method of claim 2 wherein the injecting of fuel into the combustion chamber further includes injecting fuel through a first nozzle outlet set having a larger outlet size and a smaller spray angle, and a second nozzle outlet set having a smaller outlet size and a larger spray angle.

4. The method of claim 3 wherein the injecting of fuel includes injecting from 60% to 95% of a total fuel quantity injected in the engine cycle through the first nozzle outlet set.

5. The method of claim 3 wherein the larger outlet size includes a larger nozzle outlet exit diameter and the smaller outlet size includes a smaller nozzle outlet exit diameter.

6. The method of claim 5 further comprising targeting spray jets of the fuel injected through the first nozzle outlet set along a floor of a combustion bowl formed by the combustion face, and targeting spray jets of the fuel injected through the second nozzle outlet set above the targeted spray jets of the fuel injected through the first nozzle outlet set.

7. The method of claim 1 wherein the fuel includes a liquid fuel injected through the plurality of nozzle outlet sets, and further comprising autoigniting the injected liquid fuel in the combustion chamber.

8. The method of claim 7 wherein the injecting of the fuel includes injecting the fuel through each of the plurality of nozzle outlet sets at the same injection pressure.

9. The method of claim 7 further comprising initiating the injecting of the fuel by lifting a nozzle check in a fuel injector from a closed position blocking all of the plurality of nozzle outlet sets, to an open position.

10. An engine comprising:
an engine housing having a combustion chamber formed therein, and a piston movable in the combustion chamber between a bottom dead center position and a top dead center position;
a thermal barrier coating (TBC) upon the piston and exposed to the combustion chamber; and
a fuel injector nozzle assembly within the combustion chamber and having formed therein a plurality of sets of nozzle outlets varied set-to-set with respect to both outlet size and spray angle and arranged to produce spray jets of a fuel from each respective set of the plurality of sets of nozzle outlets.

11. The engine of claim 10 wherein the piston includes a combustion face forming a combustion bowl.

12. The engine of claim 11 wherein the plurality of sets of nozzle outlets includes a first nozzle outlet set having a larger outlet size and a smaller spray angle, and a second nozzle outlet set having a smaller outlet size and a larger spray angle.

13. The engine of claim 12 wherein the TBC is upon an entirety of the combustion face of the piston.

14. The engine of claim 12 wherein the first nozzle outlet set is from 4 to 7 in number and the second nozzle outlet set is from 4 to 7 in number.

15. The engine of claim 14 wherein each of the smaller spray angle and the larger spray angle is from 120° to 160°.

16. The engine of claim 15 wherein:
each of the first nozzle outlet set and the second nozzle outlet set is 6 in number; and
the smaller spray angle is about 130° and the larger spray angle is about 160°.

17. An internal combustion system comprising:
an engine including a cylinder block, a cylinder liner in the cylinder block, a cylinder head, and a piston movable in the engine housing between a bottom dead center position and a top dead center position in an engine cycle;
a combustion chamber formed by an exposed surface of each one of the cylinder liner, the cylinder head, and the piston;
a thermal barrier coating (TBC) upon at least one of the exposed surfaces of the cylinder liner, the cylinder head, and the piston; and
a fuel injector nozzle assembly within the combustion chamber and having formed therein a plurality of sets of nozzle outlets varied set-to-set with respect to at least one of spray angle or outlet size and defining an impingement-limiting fuel spray pattern of an injected fuel based on spray jets propagated outwardly from each respective set of the plurality of sets of nozzle outlets.

18. The system of claim 17 wherein the exposed surface of the piston includes a combustion face forming a combustion bowl and a piston rim extending circumferentially around the combustion bowl, and the TBC is upon an entirety of the combustion face.

19. The system of claim 18 wherein the plurality of sets of nozzle outlets includes a first nozzle outlet set having a larger outlet size and a smaller spray angle and a second nozzle outlet set having a smaller outlet size and a larger spray angle.

20. The system of claim 19 wherein:
a number of the nozzle outlets in the first nozzle outlet set is from 4 to 7 and a number of the nozzle outlets in the second nozzle outlet set is from 4 to 7; and
each of the smaller spray angle and the larger spray angle is in range from 120° to 160°.
